(19) United States
(12) Patent Application Publication
(10) Pub. No.: US 2015/0146635 A1
(43) Pub. Date: May 28, 2015

(54) Timing Advance Management in the Presence of Repeaters and Remote Radio Heads

(71) Applicant: Nokia Solutions and Networks Oy, Espoo (FI)

(72) Inventors: Igor Filipovich, Chicago, IL (US); Ivan Vukovic, Arlington Heights, IL (US)

(73) Assignee: Nokia Solutions and Networks Oy, Espoo (FI)

(21) Appl. No.: 14/403,737

(22) PCT Filed: May 28, 2013
(86) PCT No.: PCT/EP2013/060931

§ 371 Date: Nov. 25, 2014

Related U.S. Application Data
(60) Provisional application No. 61/652,591, filed on May 29, 2012.

(51) Int. Cl. H04W 74/00; H04W 74/08

(52) U.S. Cl. CPC H04W 74/006; H04W 74/0833
USPC 370/329

(57) ABSTRACT

A method for performing time advance (TA) management is described. An assignment of a first TA group is transmitted to a mobile device. The mobile device measures a strength of a signal from a first access point (AP). The mobile device determines whether to send a random access preamble based at least in part on the strength of the signal from the first AP and a strength of a signal from a second AP. A current downlink (DL) path includes the second AP. The method includes, in response to determining to send a random access preamble, transmitting the random access preamble, the random access preamble is received from the mobile device. In response to the random access preamble, the method includes determining a second TA group for the mobile device. The method also includes transmitting an assignment of the second TA group. Apparatus and computer readable media are also described.

### TECHNICAL FIELD

The exemplary and non-limiting embodiments relate generally to wireless communication systems, methods, devices and computer programs and, more specifically, relate to timing advance management.

### BACKGROUND

This section is intended to provide a background or context. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A terminal may simultaneously receive one or multiple component carriers (CC) depending on its capabilities. A LTE-A terminal with reception capability beyond 20 MHz can simultaneously receive transmissions on multiple component carriers.

With regard to carrier aggregation (CA), what is implied is that one eNB can effectively contain more than one cell on more than one CC (frequency carrier), and the eNB can utilize one (as in E-UTRAN Rel-8) or more cells (in an aggregated manner) when assigning resources and scheduling the UE.

In cellular radio systems generally, the user equipment (UE) adjusts the timing of their transmissions to the base station so that the times when each transmitted symbol arrives at the eNB's receivers (for example, a remote radio head (RRH) and/or repeater) are within a small timing offset of the times when the eNB is expecting them. This is an example of an uplink (UL) time alignment or timing advance (TA). The timing advance compensates for the round trip propagation delay between the eNB and the UE and varies with time, due to UE mobility.

A single UE may be assigned radio resources on more than one CC. In some cases more than one CC is aligned in time and so the same timing alignment timer can be used for them all. Such timing-dependent CCs for which the UE tracks timing synchronization by a single timing alignment timer are termed a timing advance group (TAG) of CCs, and there may be one or more than one CC in any timing advance group. In other cases, at least two of the CCs assigned to the UE may be timing independent, and so the UE maintains a separate timing advance timer for each of the different timing advance groups it is assigned.

### SUMMARY

The below summary section is intended to be merely exemplary and non-limiting.

The foregoing and other problems are overcome, and other advantages are realized, by the use of the exemplary embodiments.

In a first aspect thereof an exemplary embodiment provides a method for performing TA management. The method includes measuring a strength of a signal from a first access point (AP). Determining whether to send a random access preamble based at least in part on the strength of the signal from the first AP and a strength of a signal from a second AP is included in the method. A current downlink (DL) path includes the second AP. The method also includes, in response to determining to send a random access preamble, transmitting the random access preamble.

In another aspect thereof an exemplary embodiment provides a method for performing TA management. The method includes transmitting an assignment of a first TA group. Receiving, from the mobile device, a random access preamble is included in the method. In response to the random access preamble, the method includes determining a second TA group for the mobile device. The method also includes transmitting an assignment of the second TA group.

In a further aspect thereof an exemplary embodiment provides an apparatus for performing TA management. The apparatus comprises one or more processors and one or more memories storing computer program code. The one or more memories and the computer program code are configured, with the one or more processors, to cause the apparatus to perform actions. The actions include measuring a strength of a signal from a first AP. Determining whether to send a random access preamble based at least in part on the strength of the signal from the first AP and a strength of a signal from a second AP is included in the actions. A current DL path includes the second AP. The actions also include, in response to determining to send a random access preamble, transmitting the random access preamble.

In another aspect thereof an exemplary embodiment provides an apparatus for performing TA management. The apparatus comprises one or more processors and one or more memories storing computer program code. The one or more memories and the computer program code are configured, with the one or more processors, to cause the apparatus to perform actions. The actions include transmitting an assignment of a first TA group. Receiving, from the mobile device, a random access preamble is included in the actions. In response to the random access preamble, the actions include determining a second TA group for the mobile device. The actions also include transmitting an assignment of the second TA group.

In a further aspect thereof an exemplary embodiment provides a computer program product for performing TA management. The computer program product includes a computer-readable storage medium bearing computer program code embodied therein for use with a computer. The computer program code includes code for performing actions. The actions includes measuring a strength of a signal from a first AP. Determining whether to send a random access preamble based at least in part on the strength of the signal from the first AP and a strength of a signal from a second AP is included in the actions. A current DL path includes the second AP. The actions also include, in response to determining to send a random access preamble, transmitting the random access preamble.

In another aspect thereof an exemplary embodiment provides a computer program product for performing TA management. The computer program product includes a computer-readable storage medium bearing computer program code embodied therein for use with a computer. The computer program code includes code for performing actions. The actions include transmitting an assignment of a first TA group. Receiving, from the mobile device, a random access preamble is included in the actions. In response to the random access preamble, the actions include determining a second TA group for the mobile device. The actions also include transmitting an assignment of the second TA group.

In a further aspect thereof an exemplary embodiment provides an apparatus for performing TA management. The apparatus includes means for measuring a strength of a signal from a first AP. Means for determining whether to send a random access preamble based at least in part on the strength of the signal from the first AP and a strength of a signal from a second AP is included in the apparatus A current DL path includes the second AP. The apparatus also includes means for transmitting the random access preamble in response to determining to send a random access preamble.

In another aspect thereof an exemplary embodiment provides an apparatus for performing TA management. The apparatus includes means for transmitting an assignment of a first TA group. Means for receiving, from the mobile device, a random access preamble is included in the apparatus. The apparatus includes means for determining a second TA group for the mobile device in response to the random access preamble. The apparatus also includes means for transmitting an assignment of the second TA group.

### BRIEF DESCRIPTION OF THE DRAWINGS

The foregoing and other aspects of exemplary embodiments are made more evident in the following Detailed Description, when read in conjunction with the attached Drawing Figures, wherein:

FIG. 1 shows a simplified illustration of a wireless network suitable for use in practicing various exemplary embodiments.

FIG. 2 is a logic flow diagram that illustrates the operation of an exemplary method, and a result of execution of computer program instructions embodied on a computer readable memory, in accordance with various exemplary embodiments.

FIG. 3 is a simplified signaling diagram in accordance with various exemplary embodiments.

FIG. 4 shows a simplified block diagram of exemplary electronic devices that are suitable for use in practicing various exemplary embodiments.

FIG. 5 is a logic flow diagram that illustrates the operation of a further exemplary method, and a result of execution of computer program instructions embodied on a computer readable memory, in accordance with various exemplary embodiments.

FIG. 6 is a logic flow diagram that illustrates the operation of another exemplary method, and a result of execution of computer program instructions embodied on a computer readable memory, in accordance with various exemplary embodiments.

### DETAILED DESCRIPTION

FIG. 1 shows a simplified illustration of a wireless network suitable for use in practicing various exemplary embodiments. The network includes a cell 100 served by multiple RRH 112, 114, 116 and 130. The RRH 112, 114, 116, 130 may communicate with an eNB 140 in order to provide communication paths between the eNB 140 and mobile devices, such as UE 120. The UE 120 may be assigned one (or more) RRH 112, 114, 116, 130 for use with downlink (DL) signaling. Such DL RRH provide a DL path.

The UE 120 may be configured to receive signals from one or more of the RRH 112, 114, 116, 130. In an exemplary embodiment, communications between the UE 120 and each of RRH 112, 114 and 116 have similar timing advances (TA). Thus, the set of RRH 112, 114 and 116 are assigned to a timing advance group (TAG) 110 for UE 120, while RRH 130 is not part of the TAG 110. The UE 120 may receive CA signals from the RRHs 112, 114, 116 in the TAG 110 as well as signals 135 from the non-TAG RRH 130.

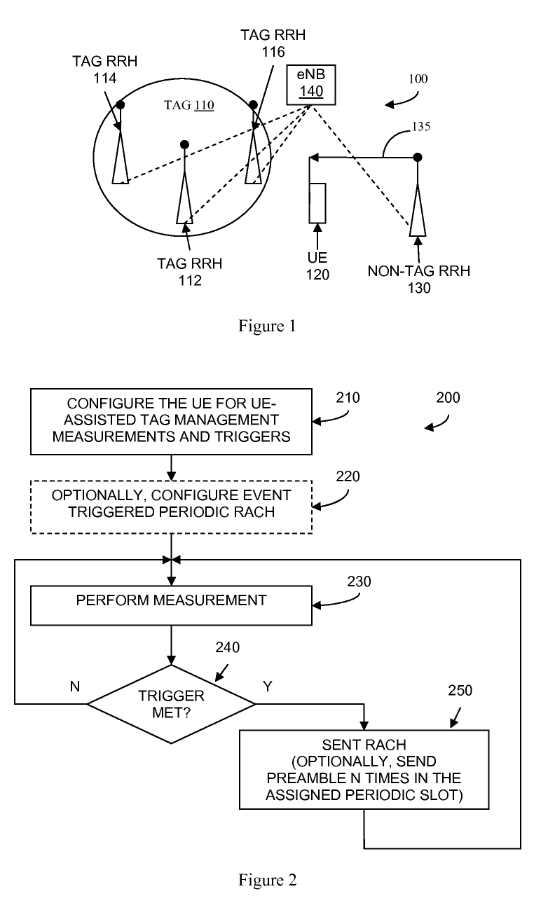

FIG. 2 is a logic flow diagram 200 that illustrates the operation of an exemplary method, and a result of execution of computer program instructions embodied on a computer readable memory, in accordance with various exemplary embodiments. At Block 210, the UE 120 is configured for UE-assisted TAG management measurements. This may be signaled to the UE 120 in various control communications, for example, when the UE 120 is assigned a TAG. Optionally, at Block 220, the UE 120 may also be assigned a periodic resource for use when signaling is trigged by an event.

At Block 230, the UE 120 performs measurements of CC signals from one or more access points 112, 114, 116, 130. These measurements may include signal strength (such as reference signal received power (RSRP) for example), TA, etc. Based on these measurements, at Block 240, the UE 120 determines whether one or more trigger conditions have been met. These trigger conditions may be a) when a non-TAG access point 130 has signal strength sufficiently stronger than a signal strength of a current DL path (such as exceeding the signal strength of a current DL path by a threshold margin for example), and/or b) when a non-TAG access point 130 has a sufficient signal strength and a timing delay which is different from the TA of the TAG by a given threshold, for example. If the trigger condition is not met (N), the UE 120 proceeds as before and continues to perform measurements.

When a trigger condition has been met (Y), the UE 120 provides an indication of the event to the eNB 140 using a random access channel (RACH) communication, at Block 250. The RACH communication may be a given preamble message. If a periodic resource (such as a frequency/time slot) has been assigned to the UE 120, the UE 120 may send the RACH communication multiple times (N times) in the assigned periodic resource. The UE 120 may then return to (or continue to) performing measurements.

Multiple remote radio reads (RRHs), and/or repeaters may be used to improve signal quality and increase user data rates by increasing the available bandwidth and providing alternative data paths. Both RRH and repeaters may be used as part of the same LTE cell and appear to the UE as a single antenna system.

The RRH and repeaters may be located at different geographical areas. This is desirable where interference may occur due to tunnels, buildings and/or high mobility of the UE. Due to different propagation delays from the UE to different repeaters/RRHs, the RF signals (corresponding to different RRHs/repeaters) reach a baseband unit at eNodeB with a large differential delay (delay difference between arrival times of different signals).

In LTE Rel-10, a UE applies the same timing advance for all active UL component carriers. However, this effectively precludes the use of component carriers being transmitted from different physical locations in LTE Rel-10. This restriction has been removed in LTE Rel-11 which uses a Timing Advance Group (TAG). A TAG is a set of the UE's serving cells which have similar propagation delays. Each of the UE's serving cells may be assigned to a different TA Group if the propagation delay on each serving cell layer is different (for example, due to RRH and repeaters)

As the UE moves and passes by different RRH/repeaters, the UE adjusts the timing of DL frame processing based on the strongest DL signal frame boundary being received. The timing of the UL transmissions may be tied to the timing of the reception of the DL frame boundary. When a UE moves and “locks” to a new DL path of the new RRH/repeater, the UE also adjusts the timing of UL transmissions.

Various access points (AP), such as RRH and/or repeaters for example, may be deployed on a given frequency layer (such as a secondary cell (SCell)) frequency layer for example). Initially, a primary cell (PCell) and a SCell can belong to the same TAG. This occurs when a UE is close to the eNB, and the eNB assigns the PCell and the SCell to the same TAG. However, as the UE moves, the strongest DL path signals from the PCell and the SCell may cease to arrive at the UE at the same time. When this happens, it would be beneficial to alert the eNB so that it may assign the SCell to a different TAG.

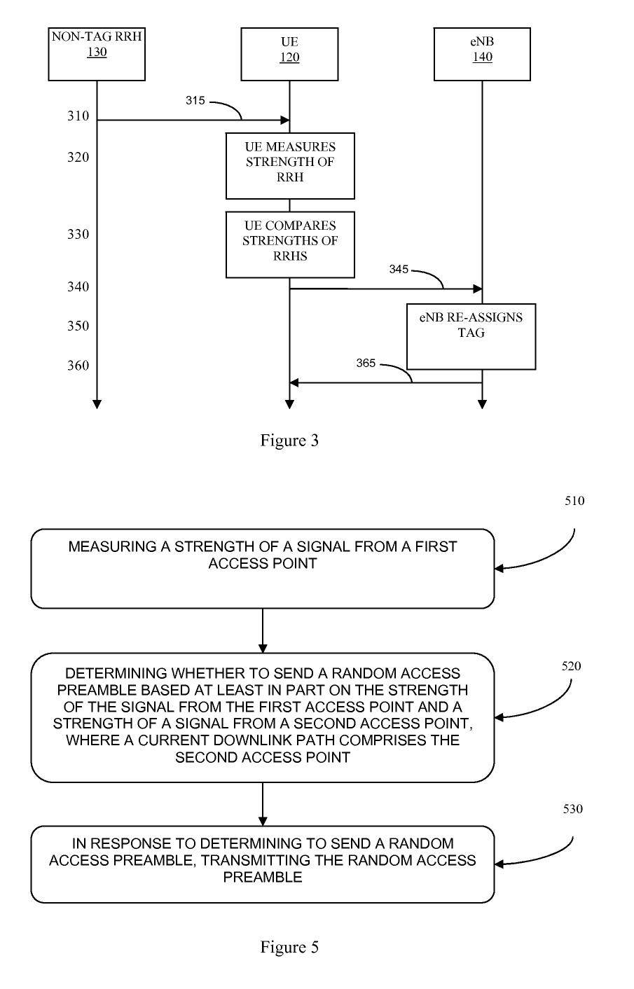

FIG. 3 is a simplified signaling diagram in accordance with various exemplary embodiments. As in FIG. 1, UE 120 is assigned a TAG 110 by eNB 140, the current TAG 110 does not include RRH 130. At time 310, the UE 120 receives a signal 315 from the non-TAG RRH 130. At time 320, the UE measures the strength of the signal 315. Note that the strength of the signal 315 may be measured when the signal 315 is received such that time 310 and 320 may occur simultaneously.

At time 330, the UE 120 compares the strength of signal 315 with the strength of signals from other RRH (such as RRH of a current DL path). Such comparisons may indicate that a trigger condition has been met, in which case, at time 340, the UE 120 indicates the event to eNB 140 using RACH signaling 345.

In response to the signal 345, the eNB 140 determines a TAG for the UE 120, at time 350. The new TAG may include RRH 130. At time 360, the eNB 140 then provides the TAG assignment via signaling 365.

Various exemplary embodiments provide mechanisms that facilitate the addition and removal of configured component carriers (CC) from one or more TAGs. Using an extension of dedicated RACH procedures, changes in TAG assignments may be efficiently detected at the eNB without unduly burdening UL resources. Once these changes are known, new TAG assignments may be made to accommodate the changed conditions.

A UE may be configured to assist management of Timing Advance groups, such as TAGs in LTE Rel-11. A DL multipath signal strength and multipath time difference may be used as trigger(s) for RACH signaling by the UE. A periodic RACH may be used for indication of the UE identity and TA group member misalignment.

An exemplary embodiment provides a method of dynamically detecting the opportunity for managing UE TAGs during call processing in a carrier aggregation network. RRC messaging may be used for configuration UE measurement of RSRP thresholds and time differential thresholds. The use of PRACH transmissions is based on UE measurement triggers to implicitly request the eNB to re-configure timing advance group tags. The dedicated periodic PRACH use may be based on same measurement triggers for low latency TA group management for high mobility users.

The UE may be configured with a specific UL Timing Advance related trigger. The trigger may occur when the UE detects a serving cell's DL path is stronger by a threshold, X dB, than the strength of the current DL path the UE is locked to and/or when the UE starts to detect a serving cell's DL path which is stronger than a threshold, X dB, and is separated from the DL path to which the UE's receiver is presently ‘locked’ to by a threshold, Y microseconds. Once the above trigger is met, the UE transmits a random access preamble. After the eNB receives the preamble, the eNB assigns the serving cell where the UE trigger was met (such as where the dedicated PRACH resource and preamble was received/detected for example) to a new TAG.

Additionally, the UE can be assigned a per-serving-cell dedicated periodic PRACH resource (such as PRACH location and PRACH preamble for example). The PRACH resource is assigned to the UE to perform a random access procedure when the UE detects that its UL transmission timing may be corrected (such as when the trigger(s) is met for example). A dedicated Periodic PRACH resource and PRACH configuration (such as a PRACH period) may be given to the UE based on various factors. These factors include the speed of the UE, a density of RRH/repeater deployments at the location of the UE and a signal strength.

Some UEs may be configured with a dedicated periodic PRACH; however, other UEs may not be so configured. The eNB may decide which UE are configured with a dedicated periodic PRACH based on the same factors as those used to assign the PRACH resources to a UE (such as UE speed, RRH density and signal strength for example).

In an exemplary embodiment, if the UE detects the change in DL timing (or a change in the DL timing and DL signal strength), the UE triggers a RACH procedure itself. The UE may perform a RACH procedure on all or a subset of PCell/SCells with the aid of the periodic RACH with a sufficiently long period to keep the overhead low. The periodic RACH may be configured based on the UE speed, location and signal strength.

By having the UE perform a RACH procedure based on a sudden change in DL timing, the eNB can make sure that the RRHs used for the UE are the most acceptable. A dedicated periodic PRACH resource may be used (such that the UE sends a PRACH preamble in each configured dedicated periodic resource), but if not tied to a trigger condition the UE would be creating unnecessary UL interference. If the UE is not assigned a dedicated resource, the random access procedure may include contention resolution steps which may also cause larger UL overhead for the procedure. The dedicated periodic PRACH resource may be assigned very sparsely and is more efficient than an ‘aloha’-like contention based PRACH where the efficiency may be as high as 36% but is often significantly lower

A method in accordance with an exemplary embodiment may be used to indicate new receiving paths by the UE, The method includes the UE detecting a signal from a plurality of signals belonging to the same receiving component carrier. This signal is determined to be X dB stronger than the signal the UE is presently receiving. Alternatively, the UE detects a signal from a plurality of signals belonging to the same receiving component carrier which is X dB stronger and Y seconds apart from the signal the UE is presently receiving.

In response to the signal meeting the trigger condition(s), the UE transmits a random access preamble. The UE may transmit the random access preamble in the pre-assigned dedicated periodic random access resource. As a response to the random access preamble, the eNB reassigns the component carrier detected by the UE to a new timing advance group.

Timing Advance group management may be enhanced by an exemplary embodiment. A UE measurement configuration (via RRC) may be used to define triggers such as detection of the DL signal X dB stronger than the signal the UE is presently receiving and/or detection of the DL signal from a plurality of signals belonging to the same receiving component carrier which is X dB stronger and Y seconds apart from the signal the UE is presently receiving, for example. A UE event is triggered by the new UE measurement upon which the UE performs a RACH procedure. The eNB may change the TA group assigned to the UE after the RACH procedure.

A modified dedicated RACH with an extended mask may be used for the event-triggered dedicated periodic RACH. When signaling a TA group assignment the eNB may insert the RACH configuration in a separate information element (IE). The UE may be configured to use the RACH configuration when a specific event has been triggered, such as upon detecting a new DL signal X dB stronger than the signal the UE is presently receiving for example.

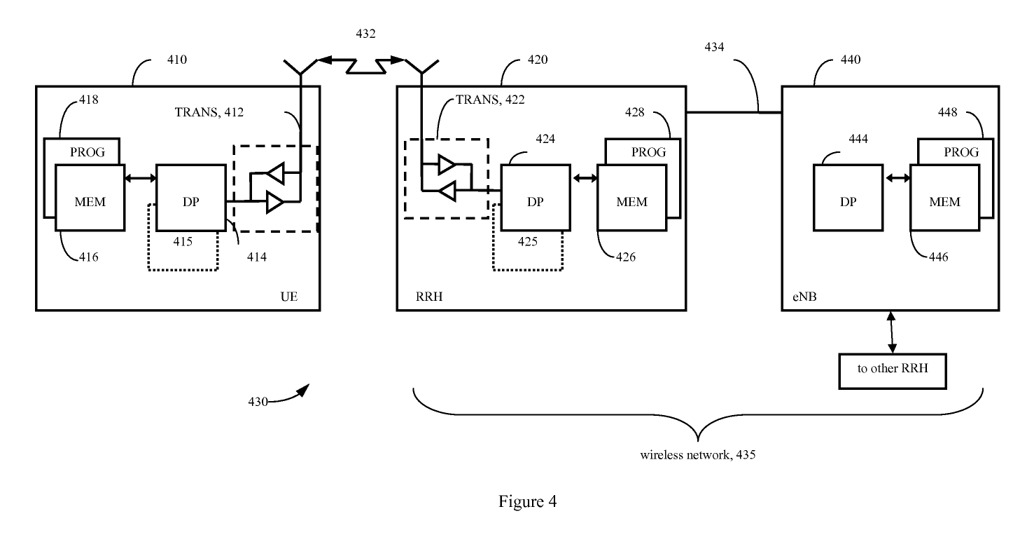

Reference is made to FIG. 4 for illustrating a simplified block diagram of various electronic devices and apparatus that are suitable for use in practicing exemplary embodiments.

In the wireless system 430 of FIG. 4, a wireless network 435 is adapted for communication over a wireless link 432 with an apparatus, such as a mobile communication device which may be referred to as a UE 410, via a network access node, such as a RRH (or repeater) 420. The network 435 may include a Node B (base station), and more specifically an eNB 440, and which provides connectivity with a network, such as a telephone network and/or a data communications network.

The UE 410 includes a controller, such as a computer or a data processor (DP) 414, a computer-readable memory medium embodied as a memory (MEM) 416 that stores a program of computer instructions (PROG) 418, and a suitable wireless interface, such as radio frequency (RF) transceiver 412, for bidirectional wireless communications with the RRH 420 via one or more antennas.

The RRH 420 also includes a controller, such as a computer or a data processor (DP) 424, a computer-readable memory medium embodied as a memory (MEM) 426 that stores a program of computer instructions (PROG) 428, and a suitable wireless interface, such as RF transceiver 422, for communication with the UE 410 via one or more antennas. The RRH 420 is coupled via a data/control path 434 to the eNB 440.

The eNB 440 includes a controller, such as a computer or a data processor (DP) 444, a computer-readable memory medium embodied as a memory (MEM) 446 that stores a program of computer instructions (PROG) 448. The eNB 440 may also be coupled to one or more additional RRH.

At least one of the PROGs 418, 428 and 448 is assumed to include program instructions that, when executed by the associated DP, enable the device to operate in accordance with exemplary embodiments, as will be discussed below in greater detail.

That is, various exemplary embodiments may be implemented at least in part by computer software executable by the DP 414 of the UE 410; by the DP 424 of the RRH 420; and/or by the DP 444 of the eNB 440, or by hardware, or by a combination of software and hardware (and firmware).

The UE 410 and the RRH 420 may also include dedicated processors, for example timing advance processor 415 and timing advance processor 425.

In general, the various embodiments of the UE 410 can include, but are not limited to, cellular telephones, tablets having wireless communication capabilities, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 416, 426 and 446 may be of any type suitable to the local technical environment and may be implemented using any suitable data storage technology, such as semiconductor based memory devices, flash memory, magnetic memory devices and systems, optical memory devices and systems, fixed memory and removable memory. The DPs 414, 424 and 444 may be of any type suitable to the local technical environment, and may include one or more of general purpose computers, special purpose computers, microprocessors, digital signal processors (DSPs) and processors based on a multicore processor architecture, as non-limiting examples. The wireless interfaces (such as, RF transceivers 412 and 422) may be of any type suitable to the local technical environment and may be implemented using any suitable communication technology such as individual transmitters, receivers, transceivers or a combination of such components.

Based on the foregoing it should be apparent that various exemplary embodiments provide a method, apparatus and computer program(s) to perform timing advance management.

FIG. 5 is a logic flow diagram that illustrates the operation of a method, and a result of execution of computer program instructions (for example, PROG 418), in accordance with exemplary embodiments. In accordance with these exemplary embodiments a method performs, at Block 510, a step of measuring a strength of a signal from a first access point. At Block 520, a step of determining whether to send a random access preamble based at least in part on the strength of the signal from the first access point and a strength of a signal from a second access point is performed by the method. A current downlink path comprises the second access point. In response to determining to send a random access preamble, the method also performs, at Block 530, a step of transmitting the random access preamble.

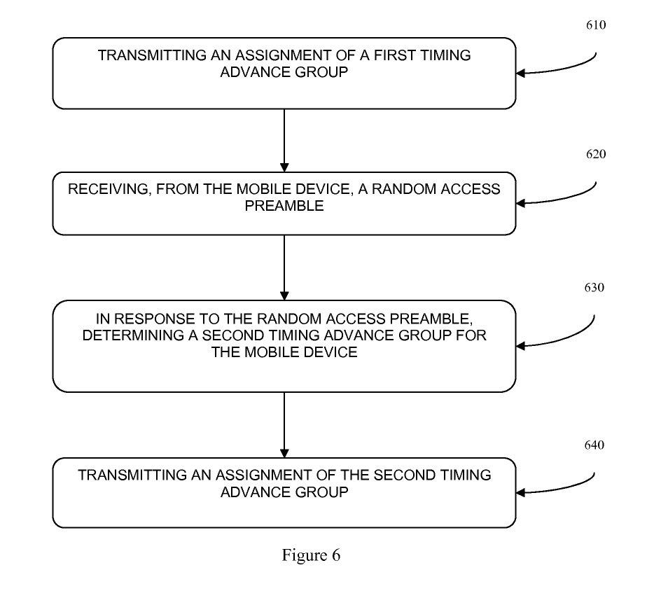

FIG. 6 is a logic flow diagram that illustrates the operation of a method, and a result of execution of computer program instructions (for example, PROG 448), in accordance with another exemplary embodiments. In accordance with these exemplary embodiments a method performs, at Block 610, a step of transmitting an assignment of a first timing advance group. At Block 620, a step of receiving, from the mobile device, a random access preamble is performed by the method. In response to receiving the random access preamble, the method performs, at Block 630, a step of in response to the random access preamble, determining a second timing advance group for the mobile device. The method also performs, at Block 640, a step of transmitting an assignment of the second timing advance group.

The various blocks shown in FIGS. 5 and 6 may be viewed as method steps, and/or as operations that result from operation of computer program code, and/or as a plurality of coupled logic circuit elements constructed to carry out the associated function(s).

An exemplary embodiment is a method for performing timing advance management. The method includes measuring (for example, by a processor) a strength of a signal from a first access point. Determining (for example, by a processor) whether to send a random access preamble based at least in part on the strength of the signal from the first access point and a strength of a signal from a second access point is included in the method. A current downlink path includes the second access point. The method also includes, in response to determining to send a random access preamble, transmitting (for example, by a transmitter) the random access preamble.

In a further exemplary embodiment of the method above, determining whether to send the random access preamble includes comparing the strength of the signal from the first access point to a strength of a signal from a second access point. When the strength of the signal from the first access point exceeds the strength of a signal from a second access point by a threshold amount (such as X dB), a determination to send the random access preamble is made.

In another exemplary embodiment of any one of the methods above, determining whether to send the random access preamble is further based on whether the signal from the first access point is at least a threshold time apart (such as Y seconds) from the signal from the second access point

In a further exemplary embodiment of any one of the methods above, the first access point includes one of: a RRH and a repeater.

In another exemplary embodiment of any one of the methods above, the method also includes receiving an assignment of a random access resource. Transmitting the random access preamble includes transmitting the random access preamble on the random access resource. The random access resource may be a dedicated physical random access channel resource. The method may also include receiving an assignment of a timing advance group. The assignment of a timing advance group may include the assignment of the random access resource.

In a further exemplary embodiment of any one of the methods above, the method also includes receiving an assignment of a first timing advance group. The first timing advance group includes the second access point. In response to transmitting the random access preamble, the method includes receiving an assignment of a second timing advance group. The second timing advance group includes the first access point.

In another exemplary embodiment of any one of the methods above, the random access preamble includes an indication of the first access point.

A further exemplary embodiment is a method for performing timing advance management. The method includes transmitting an assignment of a first timing advance group. Receiving, from the mobile device, a random access preamble is included in the method In response to the random access preamble, the method includes determining a second timing advance group for the mobile device. The method also includes transmitting an assignment of the second timing advance group.

In another exemplary embodiment of the method above, the random access preamble includes an indication of an access point. The second timing advance group may include the access point.

In a further exemplary embodiment of any one of the methods above, the method also includes determining whether the mobile device is authorized to use a random access resource. Determining whether the mobile device is authorized to use a random access resource may be based at least in part on a speed of the mobile device, a density of access points at a location of the mobile device, and/or a strength of a signal from an access point measured at the mobile device. In response to determining that the mobile device is authorized to use a random access resource, the assignment of a first timing advance group may include an authorization to use a random access resource

In another exemplary embodiment of any one of the methods above, the first access point is a RRH or a repeater.

In a further exemplary embodiment of any one of the methods above, the method also includes assigning a random access resource. Receiving the random access preamble includes receiving the random access preamble on the random access resource. There random access resource may be a dedicated physical random access channel resource.

Another exemplary embodiment is an apparatus for performing timing advance management. The apparatus comprises one or more processors (for example, DP 414, 444) and one or more memories (for example, MEM 416, 446) storing computer program code (for example, PROGs 418, 448). The one or more memories and the computer program code are configured, with the one or more processors, to cause the apparatus to perform any one of the methods above.

In a further exemplary embodiment of any one of the apparatus above, the apparatus is embodied in a mobile device.

In another exemplary embodiment of any one of the apparatus above, the apparatus is embodied in an integrated circuit.

A further exemplary embodiment is a computer program product for performing timing advance management. The computer program product includes a computer-readable storage medium (for example, MEM 416, 426) bearing computer program code (for example, PROGs 418, 428) embodied therein for use with a computer. The computer program code includes code for performing any one of the methods above.

In another exemplary embodiment of any one of the computer readable media above, the computer readable medium is a non-transitory computer readable medium (such as, CD-ROM, RAM, flash memory, etc.).

In a further exemplary embodiment of any one of the computer readable media above, the computer readable medium is a storage medium.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although not limited thereto. While various aspects of the exemplary embodiments may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments may be practiced in various components such as integrated circuit chips and modules, and that the exemplary embodiments may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments.

Various modifications and adaptations to the foregoing exemplary embodiments may become apparent to those skilled in the relevant arts in view of the foregoing description, when read in conjunction with the accompanying drawings. However, any and all modifications will still fall within the scope of the non-limiting and exemplary embodiments.

For example, while the exemplary embodiments have been described above in the context of the E-UTRAN (UTRAN-LTE) system, it should be appreciated that the exemplary embodiments are not limited for use with only this one particular type of wireless communication system, and that they may be used to advantage in other wireless communication systems such as for example (WLAN, UTRAN, GSM as appropriate).

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters are not intended to be limiting in any respect, as these parameters may be identified by any suitable names. Further, the various names assigned to different channels (such as, PRACH, RACH, etc.) are not intended to be limiting in any respect, as these various channels may be identified by any suitable names.

Furthermore, some of the features of the various non-limiting and exemplary embodiments may be used to advantage without the corresponding use of other features. As such, the foregoing description should be considered as merely illustrative of the principles, teachings and exemplary embodiments, and not in limitation thereof.

The following abbreviations that may be found in the specification and/or the drawing figures are defined as follows:

AP access point (such as an eNB, RRH, etc.)

BW bandwidth

CC component carrier

DL downlink (eNB towards UE)

eNB E-UTRAN Node B (evolved Node B)

E-UTRAN evolved UTRAN (LTE)

IE information element

LTE long term evolution of UTRAN (E-UTRAN)

MM/MME mobility management/mobility management entity

Node B base station

PCell primary cell

PRACH physical random access channel

RACH random access channel

RF radio frequency

RRC radio resource control

RRH remote radio head

RSRP reference signal received power

SCell secondary cell

TA timing advance

TAG timing advance group

UE user equipment, such as a mobile station or mobile terminal

UL uplink (UE towards eNB)

UTRAN universal terrestrial radio access network

1. A method comprising:
measuring a strength of a signal from a first access point;
determining whether to send a random access preamble based at least in part on the strength of the signal from the first access point and a strength of a signal from a second access point, where a current downlink path comprises the second access point; and
in response to determining to send a random access preamble, transmitting the random access preamble.

2. The method of claim 1, where determining whether to send the random access preamble comprises comparing the strength of the signal from the first access point to a strength of a signal from a second access point.

3. The method of claim 1, where determining whether to send the random access preamble comprises comparing the strength of the signal from the first access point to a strength of a signal from a second access point and where, when the strength of the signal from the first access point exceeds the strength of a signal from a second access point by a threshold amount, a determination to send the random access preamble is made.

4. The method of claim 1, where determining whether to send the random access preamble is further based on whether the signal from the first access point is at least a threshold time apart from the signal from the second access point.

5. The method of claim 1, where the first access point comprises one of: a RRH and a repeater.

6. The method of claim 1, further comprising receiving an assignment of a random access resource, where transmitting the random access preamble comprises transmitting the random access preamble on the random access resource.

7. The method of claim 1, further comprising receiving an assignment of a random access resource, where transmitting the random access preamble comprises transmitting the random access preamble on the random access resource and where there random access resource is a dedicated physical random access channel resource.

8. The method of claim 1, further comprising receiving an assignment of a random access resource, where transmitting the random access preamble comprises transmitting the random access preamble on the random access resource and receiving an assignment of a timing advance group, where the assignment of a timing advance group comprises the assignment of the random access resource.

9. The method of claim 1, further comprising:
receiving an assignment of a first timing advance group, where the first timing advance group comprises the second access point; and
in response to transmitting the random access preamble, receiving an assignment of a second timing advance group, where the second timing advance group comprises the first access point.

10. The method of claim 1, where the random access preamble comprises an indication of the first access point.

11. A method comprising:
transmitting an assignment of a first timing advance group;
receiving, from the mobile device, a random access preamble;
in response to the random access preamble, determining a second timing advance group for the mobile device; and
transmitting an assignment of the second timing advance group.

12. The method of claim 11, where the random access preamble comprises an indication of an access point.

13. The method of claim 11, where the random access preamble comprises an indication of an access point and where the second timing advance group comprises the access point.

14. The method of 11, further comprising determining whether the mobile device is authorized to use a random access resource.

15. The method of claim 11, further comprising determining whether the mobile device is authorized to use a random access resource and where determining whether the mobile device is authorized to use a random access resource is based at least in part on at least one of: a speed of the mobile device, a density of access points at a location of the mobile device, and a strength of a signal from an access point measured at the mobile device.

16. The method of claim 11, further comprising determining whether the mobile device is authorized to use a random access resource and where, in response to determining that the mobile device is authorized to use a random access resource, the assignment of a first timing advance group comprises an authorization to use a random access resource.

17. The method of claim 11, where the first access point comprises one of: a RRH and a repeater.

18. The method of claim 11, further comprising assigning a random access resource, where receiving the random access preamble comprises receiving the random access preamble on the random access resource.

19. The method of claim 11, further comprising assigning a random access resource, where receiving the random access preamble comprises receiving the random access preamble on the random access resource and where there random access resource is a dedicated physical random access channel resource.

20. An apparatus, comprising at least one processor; and at least one memory including computer program code, the at least one memory and the computer program code configured to, with the at least one processor, cause the apparatus to perform at least the following:
to measure a strength of a signal from a first access point;
to determine whether to send a random access preamble based at least in part on the strength of the signal from the first access point and a strength of a signal from a second access point, where a current downlink path comprises the second access point; and
in response to determining to send a random access preamble, to transmit the random access preamble.

21. The apparatus of claim 20, where, when determining whether to send the random access preamble, the at least one memory and the computer program code are further configured to cause the apparatus to compare the strength of the signal from the first access point to a strength of a signal from a second access point.

22. The apparatus of claim 20, where, when determining whether to send the random access preamble, the at least one memory and the computer program code are further configured to cause the apparatus to compare the strength of the signal from the first access point to a strength of a signal from a second access point and where, when the strength of the signal from the first access point exceeds the strength of a signal from a second access point by a threshold amount, a determination to send the random access preamble is made.

23. The apparatus of claim 20, where determining whether to send the random access preamble is further based on whether the signal from the first access point is at least a threshold time apart from the signal from the second access point.

24. The apparatus of claim 20, where the at least one memory and the computer program code are further configured to cause the apparatus to receive an assignment of a random access resource, where, when transmitting the random access preamble, the at least one memory and the computer program code are further configured to cause the apparatus to transmit the random access preamble on the random access resource.

25. The apparatus of claim 20, where the at least one memory and the computer program code are further configured to cause the apparatus to receive an assignment of a random access resource, where, when transmitting the random access preamble, the at least one memory and the computer program code are further configured to cause the apparatus to transmit the random access preamble on the random access resource and where the at least one memory and the computer program code are further configured to cause the apparatus to receive an assignment of a timing advance group, where the assignment of a timing advance group comprises the assignment of the random access resource.

26. The apparatus of claim 20, where the at least one memory and the computer program code are further configured to cause the apparatus:
to receive an assignment of a first timing advance group, where the first timing advance group comprises the second access point; and
in response to transmitting the random access preamble, to receive an assignment of a second timing advance group, where the second timing advance group comprises the first access point.

27. The apparatus of claim 20, where the random access preamble comprises an indication of the first access point.

28. An apparatus, comprising at least one processor; and at least one memory including computer program code, the at least one memory and the computer program code configured to, with the at least one processor, cause the apparatus to perform at least the following:
to transmit an assignment of a first timing advance group;
to receive, from the mobile device, a random access preamble;
in response to the random access preamble, to determine a second timing advance group for the mobile device; and
to transmit an assignment of the second timing advance group.

29. The apparatus of claim 28, where the random access preamble comprises an indication of an access point.

30. The apparatus of claim 28, where the random access preamble comprises an indication of an access point and where the second timing advance group comprises the access point.

31. The apparatus of claim 28, where the at least one memory and the computer program code are further configured to cause the apparatus to determine whether the mobile device is authorized to use a random access resource.

32. The apparatus of claim 28, where the at least one memory and the computer program code are further configured to cause the apparatus to determine whether the mobile device is authorized to use a random access resource and where, in response to determining that the mobile device is authorized to use a random access resource, the assignment of a first timing advance group comprises an authorization to use a random access resource.

33. The apparatus of claim 28, where the at least one memory and the computer program code are further configured to cause the apparatus to assign a random access resource, where, when receiving the random access preamble, the at least one memory and the computer program code are further configured to cause the apparatus to receive the random access preamble on the random access resource.

34-51. (canceled)
